(19) United States
(12) Patent Application Publication
(10) Pub. No.: US 2023/0156497 A1
(43) Pub. Date: May 18, 2023

(54) TECHNIQUES FOR LAYER 1 CROSS-LINK INTERFERENCE MEASUREMENT REPORTING

(71) Applicant: QUALCOMM Incorporated, San Diego, CA (US)

(72) Inventors: Qian ZHANG, Basking Ridge, NJ (US); Yan ZHOU, San Diego, CA (US); Navid ABEDINI, Basking Ridge, NJ (US); Tao LUO, San Diego, CA (US); Junyi LI, Fairless Hills, PA (US)

(21) Appl. No.: 17/455,523

(22) Filed: Nov. 18, 2021

(51) Int. Cl. H04W 24/08; H04B 17/345; H04W 72/08; H04L 5/00; H04W 72/04

(52) U.S. Cl. CPC H04W 24/08; H04B 17/345; H04W 72/082; H04L 5/0048; H04W 72/042

(57) ABSTRACT

Various aspects of the present disclosure generally relate to wireless communication. In some aspects, a user equipment (UE) may receive an indication of one or more layer 1 (L1) cross-link interference (CLI) measurement parameters. The UE may transmit an L1 CLI measurement report based at least in part on the one or more L1 CLI measurement parameters. Numerous other aspects are described.

### FIELD OF THE DISCLOSURE

Aspects of the present disclosure generally relate to wireless communication and to techniques and apparatuses for layer 1 (L1) cross-link interference (CLI) measurement reporting.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving an indication of one or more layer 1 (L1) cross-link interference (CLI) measurement parameters. The method may include transmitting an L1 CLI measurement report based at least in part on the one or more L1 CLI measurement parameters.

Some aspects described herein relate to a method of wireless communication performed by a base station. The method may include transmitting an indication of one or more L1 CLI measurement parameters. The method may include receiving an L1 CLI measurement report based at least in part on the one or more L1 CLI measurement parameters.

Some aspects described herein relate to a UE for wireless communication. The user equipment may include a memory and one or more processors coupled to the memory. The one or more processors may be configured to receive an indication of one or more L1 CLI measurement parameters. The one or more processors may be configured to transmit an L1 CLI measurement report based at least in part on the one or more L1 CLI measurement parameters.

Some aspects described herein relate to a base station for wireless communication. The base station may include a memory and one or more processors coupled to the memory. The one or more processors may be configured to transmit an indication of one or more L1 CLI measurement parameters. The one or more processors may be configured to receive an L1 CLI measurement report based at least in part on the one or more L1 CLI measurement parameters.

Some aspects described herein relate to a non-transitory computer-readable medium that stores a set of instructions for wireless communication by a UE. The set of instructions, when executed by one or more processors of the UE, may cause the UE to receive an indication of one or more L1 CLI measurement parameters. The set of instructions, when executed by one or more processors of the UE, may cause the UE to transmit an L1 CLI measurement report based at least in part on the one or more L1 CLI measurement parameters.

Some aspects described herein relate to a non-transitory computer-readable medium that stores a set of instructions for wireless communication by a base station. The set of instructions, when executed by one or more processors of the base station, may cause the base station to transmit an indication of one or more L1 CLI measurement parameters. The set of instructions, when executed by one or more processors of the base station, may cause the base station to receive an L1 CLI measurement report based at least in part on the one or more L1 CLI measurement parameters.

Some aspects described herein relate to an apparatus for wireless communication. The apparatus may include means for receiving an indication of one or more L1 CLI measurement parameters. The apparatus may include means for transmitting an L1 CLI measurement report based at least in part on the one or more L1 CLI measurement parameters.

Some aspects described herein relate to an apparatus for wireless communication. The apparatus may include means for transmitting an indication of one or more L1 CLI measurement parameters. The apparatus may include means for receiving an L1 CLI measurement report based at least in part on the one or more L1 CLI measurement parameters.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIGS. 3A-3C are diagrams illustrating examples of full duplex (FD) communication, in accordance with the present disclosure.

FIG. 4 is a diagram illustrating an example of physical channels and reference signals in a wireless network, in accordance with the present disclosure.

FIG. 5 is a diagram illustrating an example of configuration of layer 1 (L1) cross-link interference (CLI) measurement reporting, in accordance with the present disclosure.

FIG. 6 is a diagram illustrating an example process performed, for example, by a UE, in accordance with the present disclosure.

FIG. 7 is a diagram illustrating an example process performed, for example, by a base station, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

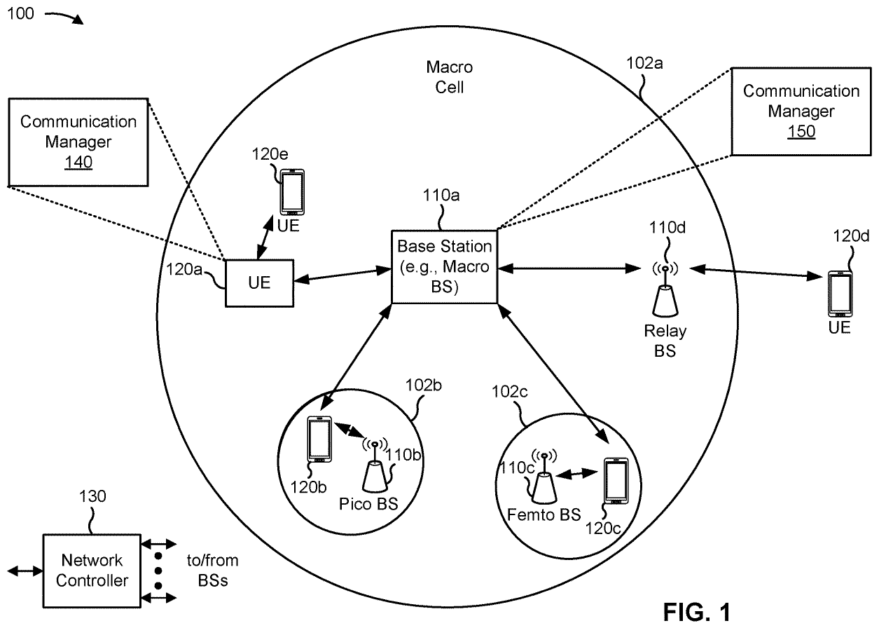

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an indication of one or more layer 1 (L1) cross-link interference (CLI) measurement parameters; and transmit an L1 CLI measurement report based at least in part on the one or more L1 CLI measurement parameters. Additionally, or alternatively, the communication manager 140 may perform one or more other operations described herein.

In some aspects, the base station 110 may include a communication manager 150. As described in more detail elsewhere herein, the communication manager 150 may transmit an indication of one or more L1 CLI measurement parameters; and receive an L1 CLI measurement report based at least in part on the one or more L1 CLI measurement parameters. Additionally, or alternatively, the communication manager 150 may perform one or more other operations described herein.

As indicated above, FIG. 1 is provided as an example. Other examples may differ from what is described with regard to FIG. 1.

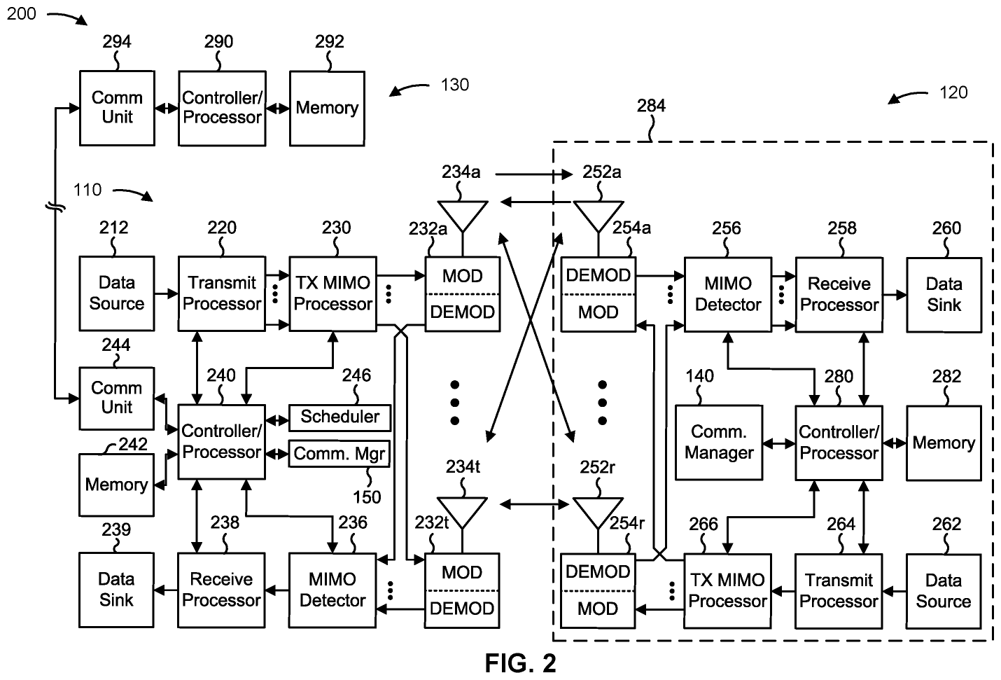

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

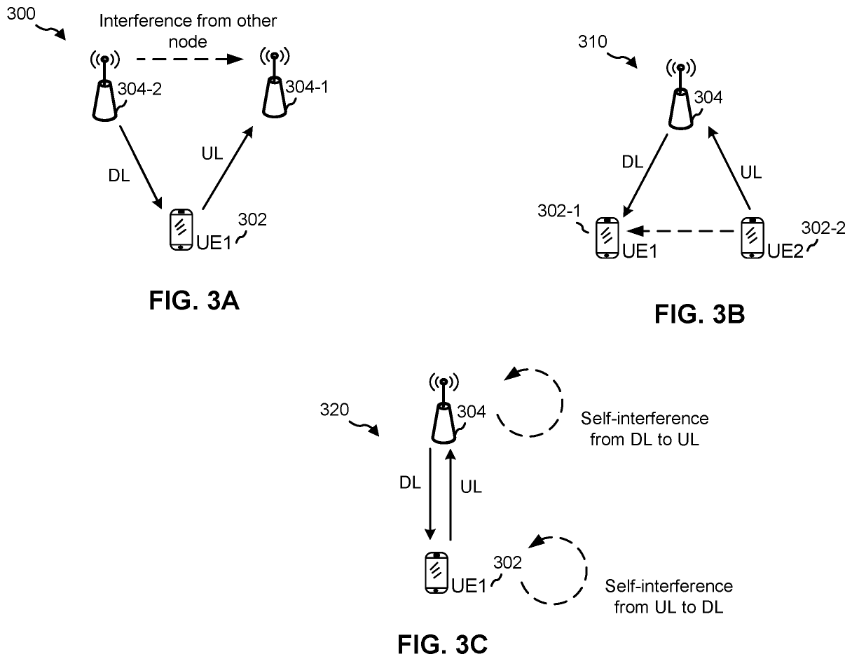

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-9).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-9).

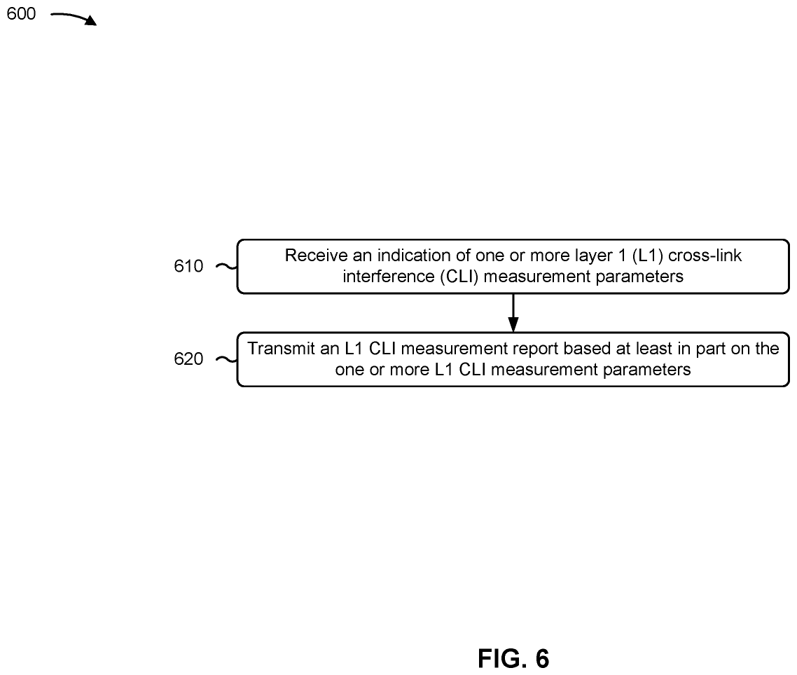

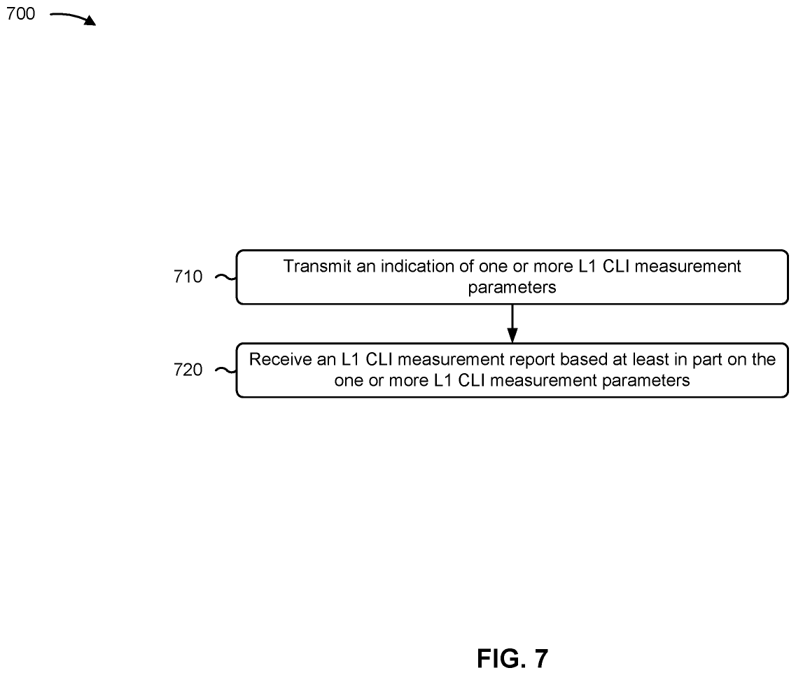

The controller/processor 240 of the base station 110, the controller/processor 280 of the UE 120, and/or any other component(s) of FIG. 2 may perform one or more techniques associated with L1 CLI measurement reporting, as described in more detail elsewhere herein. For example, the controller/processor 240 of the base station 110, the controller/processor 280 of the UE 120, and/or any other component(s) of FIG. 2 may perform or direct operations of, for example, process 600 of FIG. 6, process 700, of FIG. 7, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, the UE 120 includes means for receiving an indication of one or more L1 CLI measurement parameters; and/or means for transmitting an L1 CLI measurement report based at least in part on the one or more L1 CLI measurement parameters. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for transmitting an indication of one or more L1 CLI measurement parameters; and/or means for receiving an L1 CLI measurement report based at least in part on the one or more L1 CLI measurement parameters. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

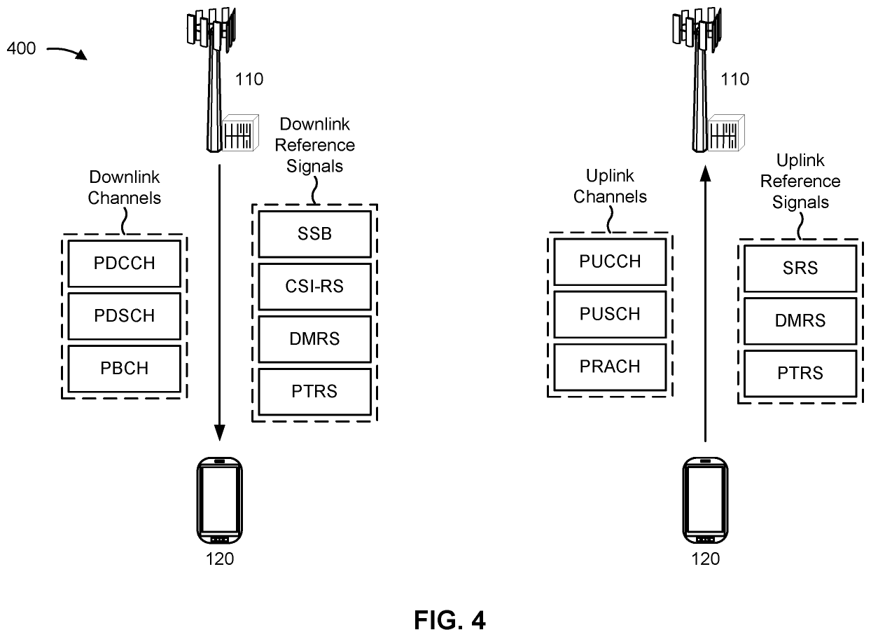

FIGS. 3A-3C are diagrams illustrating examples 300, 310, 320 of full duplex (FD) communication in accordance with the present disclosure. An FD communication is a communication that utilizes overlapped time resources at a single node (such as a UE or a base station) for transmission and reception. For example, a UE or a base station may perform a transmission and a reception using the same time resources, such as via frequency division multiplexing (FDM) or spatial division multiplexing (SDM). “FDM” refers to performing two or more communications using different frequency resource allocations. “SDM” refers to performing two or more communications using different spatial parameters, such as different transmission configuration indicator (TCI) states corresponding to beams. An SDM communication can use overlapped time resources and frequency resources, and an FDM communication can use overlapped time resources and spatial resources (that is, overlapped beam parameters, TCI states, or the like). A TCI state indicates a spatial parameter for a communication. For example, a TCI state for a communication may identify a source signal (such as a synchronization signal block, a channel state information reference signal, or the like) and a spatial parameter to be derived from the source signal for the purpose of transmitting or receiving the communication. For example, the TCI state may indicate a quasi-colocation (QCL) type. A QCL type may indicate one or more spatial parameters to be derived from the source signal. The source signal may be referred to as a QCL source. FD communications can include dynamic traffic (such as scheduled by downlink control information (DCI)) and/or semi-static traffic. Semi-static traffic is traffic associated with a semi-persistent resource, such as a semi-persistent scheduling (SPS) configured resource or a configured grant (CG), as described in more detail in connection with FIG. 4.

The example 300 of FIG. 3A includes a UE1 302 and two base stations (e.g., TRPs) 304-1, 304-2, wherein the UE1 302 is sending UL transmissions to base station 304-1 and is receiving DL transmissions from base station 304-2. In the example 300 of FIG. 3A, FD is enabled for the UE1 302, but not for the base stations 304-1, 304-2. Thus, the base stations 304-1 and 304-2 are half duplex (HD) base stations. The example 310 of FIG. 3B includes two UEs, UE1 302-1 and UE2 302-2, and a base station 304, wherein the UE1 302-1 is receiving a DL transmission from the base station 304 and the UE2 302-2 is transmitting a UL transmission to the base station 304. In the example 310 of FIG. 3B, FD is enabled for the base station 304, but not for the UE1 302-1 and UE2 302-2. Thus, the UE1 302-1 and UE2 302-2 are half duplex UEs. The example 320 of FIG. 3C includes a UE1 302 and a base station 304, wherein the UE1 302 is receiving a DL transmission from the base station 304 and the UE1 302 is transmitting a UL transmission to the base station 304. In the example 320 of FIG. 3C, FD is enabled for both the UE1 302 and the base station 304. In the example 320 of FIG. 3C, the UE1 302 and the base station 304 communicate using a beam pair. A beam pair may include a downlink beam and an uplink beam. For example, a UE1 302 may use a beam pair that includes a downlink beam (that is, a receive beam) at the UE1 302 and an uplink beam (that is, a transmit beam) at the UE1 302 to communicate with the base station 304. The base station 304 may use a downlink beam (that is, a transmit beam) at the base station 304 to transmit communications received via the UE1 302's downlink beam, and may use an uplink beam (that is, a receive beam) at the base station 304 to receive communications transmitted via the UE1 302's uplink beam.

In FIGS. 3A-3C, interference is indicated by dashed lines. Interference can occur between nodes of examples 300, 310, 320 (referred to as “cross-link interference” (CLI)). Examples of CLI are shown in FIGS. 3A and 3B. In FIG. 3A, BS 304-2's downlink transmission interferes with BS 304-1's uplink transmission. In FIG. 3B, UE1 302-1's uplink transmission interferes with UE2 302-2's downlink transmission. In some cases, self-interference can occur. Self-interference occurs when a node's transmission interferes with a reception operation of the node. For example, self-interference may occur due to reception by a receive antenna of radiated energy from a transmit antenna, cross-talk between components, or the like. Examples of self-interference at a UE 302 (from an uplink transmission to a downlink reception) and at a BS 304 (from a downlink transmission to an uplink reception) are shown in FIG. 3C. It should be noted that the above-described CLI and self-interference conditions can occur in HD deployments and in FD deployments.

As indicated above, FIGS. 3A-3C are provided as one or more examples. Other examples may differ from what is described with regard to FIGS. 3A-3C.

FIG. 4 is a diagram illustrating an example 400 of physical channels and reference signals in a wireless network, in accordance with the present disclosure. As shown in FIG. 4, downlink channels and downlink reference signals may carry information from a base station 110 to a UE 120, and uplink channels and uplink reference signals may carry information from a UE 120 to a base station 110.

As shown, a downlink channel may include a physical downlink control channel (PDCCH) that carries DCI, a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the base station 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The base station 110 may configure a set of CSI-RSs for the UE 120, and the UE 120 may measure the configured set of CSI-RSs. Based at least in part on the measurements, the UE 120 may perform channel estimation and may report channel estimation parameters to the base station 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The base station 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the base station 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring base stations in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the base station 110 may then calculate a position of the UE 120 based on the RSTD measurements reported by the UE 120.

An SRS may carry information used for uplink channel estimation, which may be used for scheduling, link adaptation, precoder selection, or beam management, among other examples. The base station 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The base station 110 may measure the SRSs, may perform channel estimation based at least in part on the measurements, and may use the SRS measurements to configure communications with the UE 120.

As indicated above, FIG. 4 is provided as an example. Other examples may differ from what is described with regard to FIG. 4.

As described above, UEs communicating with a full-duplex (FD) base station (as in example 310 of FIG. 3B) may experience CLI. For example, a first UE's uplink transmission may cause CLI with regard to a second UE's downlink transmission. This CLI can be exacerbated by the use of certain beams for transmission or reception of communications, such as if the first UE's transmit beam is aligned with the second UE's receive beam. If the base station is unaware of CLI caused by the second UE, the base station may select inappropriate resources for FD communication with the UEs, thereby causing CLI between the first UE, which reduces throughput and reliability of communications with the first UE.

In some cases, the second UE (referred to as a receive (Rx) UE) may provide a CLI measurement report to the base station to report CLI caused by the first UE's (referred to as a transmit (Tx) UE) uplink transmission. However, CLI measurement reporting may suffer from various drawbacks that can reduce the effectiveness of UE-to-UE beam pair linking for CLI mitigation and control based at least in part on CLI measurement reporting. For example, the second UE may select a receive beam for which to perform CLI measurement, where the selection of the receive beam is up to the second UE's implementation. As a result, the base station may be unaware of CLI experienced on other receive beams for the second UE due to a lack of coordination of receive beams for CLI measurement. As another example, the base station may configure CLI measurement parameters for periodic or event-triggered CLI measurement reporting by the second UE, but may be unable to configure CLI measurement parameters for aperiodic and/or semi-persistent CLI measurement reporting. As another example, the second UE may transmit a layer 3 (L3) CLI measurement report to report CLI to the base station. However, L3 CLI measurement reports are filtered (e.g., using thresholds, event triggers, measurement averages, etc.) over time and have different triggering information elements (IE). As a result, L3 CLI measurement reporting may be a relatively slow procedure that is not suitable for fast layer 1 (L1) beam selection based at least in part on quick and/or sudden variation in channel conditions and/or interference.

Some techniques and apparatuses described herein provide L1 CLI measurement reporting. In some aspects, a base station may provide one or more L1 CLI measurement parameters to an Rx UE (e.g., a UE that experiences CLI with reception on a receive beam from a base station caused by a transmission of a Tx UE) for L1 CLI measurement reporting. The Rx UE may receive the one or more L1 CLI measurement parameters, may perform one or more L1 CLI measurements based at least in part on the one or more L1 CLI measurement parameters, and may transmit an L1 CLI measurement report to the base station to report results of the one or more L1 CLI measurement parameters. In this way, the Rx UE is enabled to provide low-latency L1 (e.g., unfiltered) CLI measurement results to the base station for fast L1 receive beam selection to mitigate the effects of quick and/or sudden changes in channel conditions and interference. Moreover, the one or more L1 CLI measurement parameters may indicate a receive beam for which the Rx UE is to perform the one or more L1 CLI measurements, which enables UE-to-UE beam pair linking for CLI mitigation and/or control. Further, the one or more L1 CLI measurement parameters may indicate measurement resources and/or reporting types for the Rx UE, which enables aperiodic and/or semi-persistent CLI measurement reporting for the Rx UE.

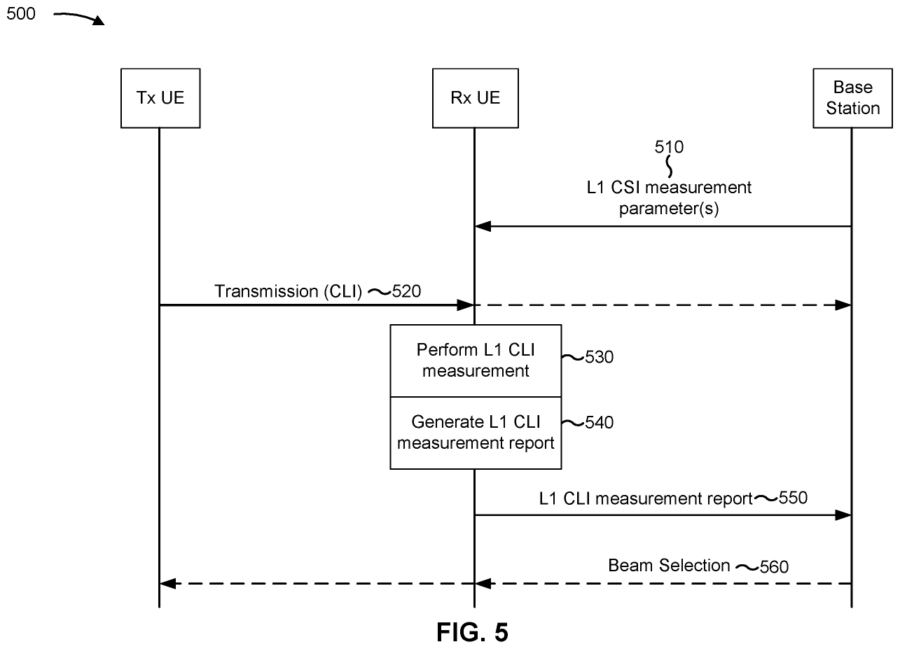

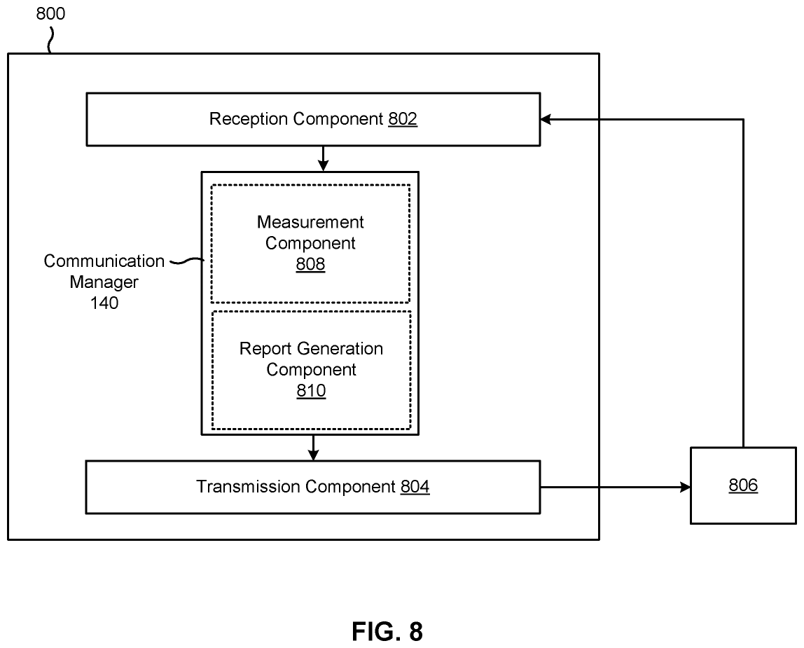

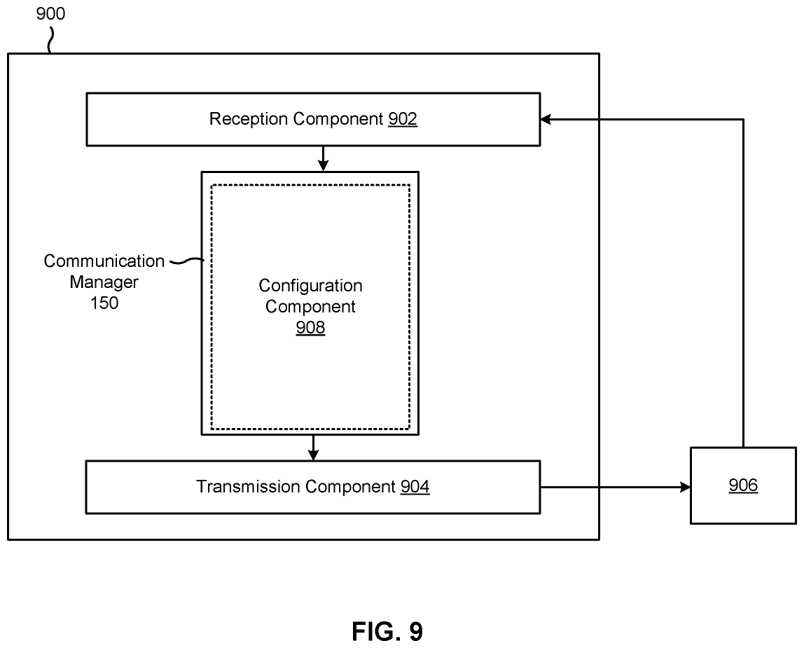

FIG. 5 is a diagram illustrating an example 500 of configuration of L1 CLI measurement reporting, in accordance with the present disclosure. Example 500 includes an Rx UE (e.g., UE 120, UE 302-1, apparatus 800 described in connection with FIG. 8), a Tx UE (e.g., UE 120, UE 302-2), and a base station (e.g., BS 110, BS 304, apparatus 900 described in connection with FIG. 9).

As shown by reference number 510, the base station may transmit, and the Rx UE may receive, an indication of one or more L1 CLI measurement parameters. For example, the indication of one or more L1 CLI measurement parameters may be transmitted via radio resource control (RRC) signaling, medium access control (MAC) signaling, DCI, or a combination thereof. In some aspects, the base station transmits the indication of one or more L1 CLI measurement parameters in an L1 CLI measurement configuration.

The one or more L1 CLI measurement parameters include parameters for performing L1 CLI measurements, for generating an L1 CLI measurement report based at least in part on results the L1 CLI measurements, and/or for transmitting the L1 CLI measurement report. The one or more L1 CLI measurement parameters may include, for example, a parameter indicating a timing for when the Rx UE is to perform L1 CLI measurements, a parameter indicating resources (e.g., time domain resources, frequency domain resources, spatial domain resources, reference signals, receive beams) on which the Rx UE is to perform L1 CLI measurements, a parameter indicating one or more measurement types for performing L1 CLI measurements, a parameter indicating a timing for transmitting the L1 CLI measurement report, a parameter indicating the content that is to be included in the L1 CLI measurement report, and/or another parameter.

In some aspects, the base station transmits (and the Rx UE receives) the indication of the one or more L1 CLI measurement parameters in a resource configuration IE associated with another type of measurement reporting. In other words, the indication of the one or more L1 CLI measurement parameters is “piggybacked” with a resource configuration IE associated with another type of measurement reporting such as CSI measurement reporting. For example, the base station may transmit the indication of the one or more L1 CLI measurement parameters in a CSI resource configuration IE such as an L1 CSI resource configuration (CSI-ResourceConfig) IE. The one or more L1 CLI measurement parameters indicated in the L1 CSI resource configuration may include, for example, an SRS resource set list (srs-ResourceSetList) that identifies one or more SRS resources in which the Rx UE is to perform RSRP L1 CLI measurements (e.g., L1-SRS-RSRP measurements), and/or a CLI RSSI resource set list (cli-RSSI-ResourceSetList) that identifies one or more resources in which the Rx UE is to perform RSSI L1 CLI measurements (e.g., L1-CLI-RSSI) measurements.

The one or more L1 CLI measurement parameters may be indicated in the L1 CSI resource configuration IE as:

srs-ResourceSetList SEQUENCE (SIZE (1..maxNrofSRS-
ResourceSetsPerConfig)) OF SRS-ResourceSetId
cli-RSSI-ResourceSetList SEQUENCE (SIZE (1..maxNrofCLI-RSSR-
ResourceSetsPerConfig)) OF CLI-RSSI-ResourceSetId

The L1 CSI resource configuration IE may further indicate a reporting type for L1 CLI measurement reporting, such as aperiodic L1 CLI measurement reporting, semi-persistent L1 CLI measurement reporting, or periodic L1 CLI measurement reporting, among other examples. The reporting type may be indicated in the L1 CSI resource configuration IE as:

resourceType ENUMERATED {aperiodic, semiPersistent, periodic} In this way, the base station may configure the Rx UE to provide periodic L1 CLI measurement reports, aperiodic L1 CLI measurement reports, and/or semi-persistent L1 CLI measurement reports, among other examples.

In some aspects, the base station transmits (and the Rx UE receives) the indication of the one or more L1 CLI measurement parameters in a resource configuration IE dedicated for L1 CLI measurement reporting. For example, the base station may transmit the indication of the one or more L1 CLI measurement parameters in an L1 CLI resource configuration (CLI-ResourceConfig or L1-CLI-ResourceConfig) IE. The one or more L1 CLI measurement parameters indicated in the L1 CLI resource configuration may include, for example, an SRS resource set list (srs-ResourceSetList) that identifies one or more SRS resources in which the Rx UE is to perform RSRP L1 CLI measurements (e.g., L1-SRS-RSRP measurements), and/or a CLI RSSI resource set list (cli-RSSI-ResourceSetList) that identifies one or more resources in which the Rx UE is to perform RSSI L1 CLI measurements (e.g., L1-CLI-RSSI) measurements. The one or more L1 CLI measurement parameters may be indicated in the L1 CLI resource configuration IE as:

```
CLI-ResourceConfig ::= SEQUENCE {
  cli-ResourceConfigId CLI-ResourceConfigId,
  cli-RS-ResourceSetList CHOICE {
    srs-ResourceSetList SEQUENCE (SIZE (1..maxNrofSRS-
ResourceSetsPerConfig)) OF SRS-ResourceSetId
    cli-RSSI-ResourceSetList SEQUENCE (SIZE
(1..maxNrofCLI-RSSR-ResourceSetsPerConfig)) OF
CLI-RSSI-ResourceSetId
```

The L1 CLI resource configuration IE may further indicate a reporting type for L1 CLI measurement reporting, such as aperiodic L1 CLI measurement reporting, semi-persistent L1 CLI measurement reporting, or periodic L1 CLI measurement reporting, among other examples. The reporting type may be indicated in the L1 CLI resource configuration IE as:

resourceType ENUMERATED {aperiodic, semiPersistent, periodic} In this way, the base station may configure the Rx UE to provide periodic L1 CLI measurement reports, aperiodic L1 CLI measurement reports, and/or semi-persistent L1 CLI measurement reports, among other examples.

In some aspects, the base station transmits (and the Rx UE receives) the indication of the one or more L1 CLI measurement parameters in an SRS resource configuration for CLI (e.g., SRS-ResourceConfigCLI). The SRS resource configuration for CLI may include, for example, an indication of receive quasi-co-location (QCL) information for the Rx UE to perform L1 CLI measurements. The receive QCL information may identify one or more receive beams, associated with the Rx UE, for which the Rx UE is to perform L1 CLI measurements. Additionally and/or alternatively, the SRS resource configuration for CLI may include a panel identifier (e.g., a receive antenna panel identifier) associated with the one or more receive beams. In some aspects, the receive QCL information is indicated in the SRS resource configuration for CLI as:

qcl-info SEQUENCE (SIZE(1..maxNrofAP-CSI-RS-ResourcesPerSet)) OF
TCI-
StateId

In some aspects, the base station transmits (and the Rx UE receives) the indication of the one or more L1 CLI measurement parameters in an RSSI resource configuration for CLI (e.g., RSSI-ResourceConfigCLI). The RSSI resource configuration for CLI may include, for example, an indication of receive QCL information and/or the panel identifier associated with the or more receive beams. In some aspects, the receive QCL information is indicated in the RSSI resource configuration for CLI as:

qcl-info SEQUENCE (SIZE(1..maxNrofAP-CSI-RS-ResourcesPerSet)) OF
TCI-
StateId

In some aspects, the base station transmits (and the Rx UE receives) the indication of the one or more L1 CLI measurement parameters in a report configuration IE associated with another type of measurement reporting. In other words, the indication of the one or more L1 CLI measurement parameters is “piggybacked” with a report configuration IE associated with another type of measurement reporting such as CSI measurement reporting. For example, the base station may transmit the indication of the one or more L1 CLI measurement parameters in a CSI report configuration IE such as an L1 CSI report configuration (CSI-ReportConfig) IE. The one or more L1 CLI measurement parameters indicated in the L1 CSI report configuration may include, for example, a resource for CLI measurement indicated in one or more resourcesForCLIMeasurement fields or another field in the L1 CSI report configuration. The resourcesForCLIMeasurement field(s) may indicate the resource for CLI measurement by linking to the SRS resource configuration identifier (SRS-ResourceConfigId) associated with the L1 CSI resource configuration and/or to the CLI-RSSI resource configuration identifier (CLI-RSSI-ResourceConfigId) associated with the L1 CSI resource configuration. As another example, one or more L1 CLI measurement parameters indicated in the L1 CSI report configuration may include one or more CLI measurement types (or CLI metrics) that are to be performed, such as RSRP L1 CLI measurements (e.g., CLI-SRS-RSRP measurements), CLI RSSI measurements (CLI-RSSI measurements), and/or other types of CLI measurements.

The one or more L1 CLI measurement parameters may be indicated in the L1 CSI report configuration IE as:

| resourcesForCLIMeasurement | SRS-ResourceConfigId, |
|---|---|
| resourcesForCLIMeasurement | CLI-RS SI-ResourceConfigId |
| ... | |
| CLI-SRS-RSRP, | NULL |
| CLI-RSSI, | NULL |

In some aspects, the base station transmits (and the Rx UE receives) the indication of the one or more L1 CLI measurement parameters in a report configuration IE dedicated for L1 CLI measurement reporting. For example, the base station may transmit the indication of the one or more L1 CLI measurement parameters in an L1 CLI report configuration (CLI-ReportConfig or L1-CLI-ReportConfig) IE. The one or more L1 CLI measurement parameters indicated in the L1 CLI report configuration may include, for example, a resource for CLI measurement indicated in one or more resourcesForCLIMeasurement fields or another field in the L1 CLI report configuration. The resourcesForCLIMeasurement field(s) may indicate the resource for CLI measurement by linking to the SRS resource configuration identifier (SRS-ResourceConfigId) associated with the L1 CLI resource configuration and/or to the CLI-RSSI resource configuration identifier (CLI-RSSI-ResourceConfigId) associated with the L1 CLI resource configuration. As another example, one or more L1 CLI measurement parameters indicated in the L1 CLI report configuration may include one or more CLI measurement types (or CLI metrics) that are to be performed, such as RSRP L1 CLI measurements (e.g., CLI-SRS-RSRP measurements), CLI RSSI measurements (CLI-RSSI measurements), and/or other types of CLI measurements.

The one or more L1 CLI measurement parameters may be indicated in the L1 CLI report configuration IE as:

| CLI-ReportConfig ::= | SEQUENCE { | |
|---|---|---|
| reportConfigId | CLI-ReportConfigId, | |
| carrier | ServCellIndex | OPTIONAL, -- Need S |

| | |
|---|---|
| resourcesForCLIMeasurement | SRS-ResourceConfigId, |
| resourcesForCLIMeasurement | CLI-RSSI-ResourceConfigId,... |

| | |
|---|---|
| CLI-SRS-RSRP, | NULL |

| | |
|---|---|
| CLI-RSSI , | NULL |

In some aspects, the base station transmits (and the Rx UE receives) the indication of the one or more L1 CLI measurement parameters for aperiodic CLI measurement reporting. The one or more L1 CLI measurement parameters for aperiodic CLI measurement reporting may be included in a DCI communication and/or another type of communication. The one or more L1 CLI measurement parameters for aperiodic CLI measurement reporting may include one or more trigger states that are configured to cause or trigger the Rx UE to provide an aperiodic L1 CLI measurement report. The one or more L1 CLI measurement parameters for aperiodic CLI measurement reporting may be indicated in a CLI aperiodic trigger state list (CLI-AperiodicTriggerStateList) IE. Each codepoint in the DCI field “CLI request” is associated with a trigger state. The Rx UE may receive a value associated with a trigger state of the one or more trigger states, may perform one or more L1 CLI measurements (e.g., one or more measurements of reference signals such as SSB-RSRP and/or CLI-RSSI, among other examples) based at least in part on receiving the value associated with the trigger state, and may transmit an aperiodic L1 CLI measurement report to the base station to provide results of the one or more L1 CLI measurements. The Rx UE may provide results of L1 CLI measurements or metrics according to entries in the associated report configuration information list (associatedReportConfigInfoList) for the trigger state. The one or more trigger states may be indicated in the CLI aperiodic trigger state list IE as:

CLI-AperiodicTriggerStateList ::= SEQUENCE (SIZE (1..maxNrOfCSI-
AperiodicTriggers)) OF CLI-AperiodicTriggerState
CLI-AperiodicTriggerState ::= SEQUENCE {
associatedReportConfigInfoList SEQUENCE
(SIZE(1..maxNrofReportConfigPerAperiodicTrigger)) OF CLI-
AssociatedReportConfigInfo,

Moreover, the CLI aperiodic trigger state list IE may indicate one or more resources or resource sets for the L1 CLI measurements. As an example, the CLI aperiodic trigger state list IE may link to the CSI report configuration identifier (CSI-ReportConfigId) associated with the L1 CSI report configuration IE described above and/or to the CLI report configuration identifier (CLI-ReportConfigId) associated with the L1 CLI report configuration IE described above as the indication of the one or more resources or resource sets for the L1 CLI measurements.

In some aspects, the base station transmits (and the Rx UE receives) the indication of the one or more L1 CLI measurement parameters for semi-persistent CLI measurement reporting. The one or more L1 CLI measurement parameters for semi-persistent CLI measurement reporting may be included in a DCI communication, a medium access control control element (MAC-CE) communication, an RRC communication, and/or another type of communication. The one or more L1 CLI measurement parameters for semi-persistent CLI measurement reporting may include one or more trigger states that are configured to cause or trigger the Rx UE to provide a semi-persistent L1 CLI measurement report on PUSCH. The one or more L1 CLI measurement parameters for semi-persistent CLI measurement reporting may be indicated in a CLI semi-persistent on PUSCH trigger state list (CLI-SemiPersistentonPUSCH-TriggerStateList) IE. The Rx UE may receive a value associated with a trigger state of the one or more trigger states, may perform one or more L1 CLI measurements (e.g., one or more measurements of reference signals such as SRS-RSRP and/or CLI-RSSI, among other examples) based at least in part on receiving the value associated with the trigger state, and may transmit a semi-persistent L1 CLI measurement report to the base station to provide results of the one or more L1 CLI measurements. The Rx UE may provide results of L1 CLI measurements or metrics according to entries in the associated report configuration information list (associatedReportConfigInfoList) for the trigger state. The one or more trigger states may be indicated in the CLI semi-persistent on PUSCH trigger state list IE as:

```
CLI-SemiPersistentOnPUSCH-TriggerStateList ::=
    SEQUENCE(SIZE (1..maxNrOfSemiPersistentPUSCH-
Triggers)) OF CLI-SemiPersistentOnPUSCH-TriggerState
CLI-SemiPersistentOnPUSCH-TriggerState ::= SEQUENCE {
  associatedReportConfigInfo CLI-ReportConfigId
```

Moreover, the CLI semi-persistent on PUSCH trigger state list IE may indicate one or more resources or resource sets for the L1 CLI measurements. As an example, the CLI semi-persistent on PUSCH trigger state list IE may link to the CSI report configuration identifier (CSI-ReportConfigId) associated with the L1 CSI report configuration IE described above and/or to the CLI report configuration identifier (CLI-ReportConfigId) associated with the L1 CLI report configuration IE described above as the indication of the one or more resources or resource sets for the L1 CLI measurements.

In some aspects, the base station transmits (and the Rx UE receives) an indication of one or more L1 CLI measurement parameters for semi-persistent CLI measurement reporting in a MAC-CE communication that activates and/or deactivates (e.g., that selectively activates or deactivates) L1 CLI measurement reporting for the Rx UE. The activation of L1 CLI measurement reporting in the MAC-CE communication may include an indication of a value associated with a trigger state, may include another value associated with activation of L1 CLI measurement reporting, may include a MAC-CE activation, and/or may include another indication of activation of L1 CLI measurement reporting. The activation of L1 CLI measurement reporting may include an activation of L1 CLI measurement reporting on PUSCH for the Rx UE. Moreover, the MAC-CE communication may indicate one or more resources or resource sets for L1 CLI measurements for the Rx UE. As an example, the MAC-CE communication may link to the CSI report configuration identifier (CSI-ReportConfigId) associated with the L1 CSI report configuration IE described above and/or to the CLI report configuration identifier (CLI-ReportConfigId) associated with the L1 CLI report configuration IE described above as the indication of the one or more resources or resource sets for the L1 CLI measurements.

In some aspects, the base station transmits (and the Rx UE receives) respective subsets of the one or more L1 CLI measurement parameters in a plurality of different communications, IEs, and/or fields. For example, the base station transmits (and the Rx UE receives) the indication of a first subset of the one or more L1 CLI measurement parameters in a resource configuration (e.g., a CSI resource configuration, an L1 CLI resource configuration), a second subset of the one or more L1 CLI measurement parameters in a resource configuration for CLI (e.g., an SRS resource configuration for CLI, an RSSI resource configuration for CLI), a third subset of the one or more L1 CLI measurement parameters in a report configuration (e.g., a CSI report configuration, an L1 CLI report configuration), a fourth subset of the one or more L1 CLI measurement parameters in an aperiodic trigger state list IE (e.g., a CLI-AperiodicTriggerStateList IE for CLI), a fifth subset of the one or more L1 CLI measurement parameters in a semi-persistent PUSCH trigger state list IE (e.g., a CLI-SemiPersistentonPUSCH-TriggerStateList IE for CLI), and/or a sixth subset of the one or more L1 CLI measurement parameters in a MAC-CE communication (e.g., a MAC-CE for activating and/or deactivating semi-persistent CSI reporting on PUCCH for CLI), among other examples.

As shown by reference number 520, the Tx UE performs a transmission (e.g., a transmission that may cause CLI for downlink reception for the Rx UE). In some aspects, the base station configures the Tx UE to transmit a reference signal. For example, the base station may configure the Tx UE to transmit a reference signal to facilitate the measurement of L1 CLI by the Rx UE. In some aspects, the base station configures the Tx UE to transmit an SRS. In some aspects, the base station configures the Tx UE to transmit an uplink DMRS. In some aspects, the base station configures the Tx UE to transmit the reference signal on a particular transmit beam or a particular set of transmit beams (e.g., in sequence), which may facilitate the identification, by the base station, of transmit beams (or combinations of a transmit beam at the Tx UE and a receive beam at the Rx UE) that are suitable, or that are unsuitable, for communication (such as FD communication).

As shown by reference number 530, the Rx UE may perform one or more L1 CLI measurements (e.g., one or more unfiltered CLI measurements) of the transmission by the Tx UE. As shown by reference number 540, the Rx UE may generate an L1 CLI measurement report based at least in part on results of the one or more L1 CLI measurements. The Rx UE may perform the measurement in accordance with the one or more L1 CLI measurement parameters provided by the base station at reference number 510. For example, the Rx UE may perform periodic L1 CLI measurements based at least in part on the one or more L1 CLI measurement parameters configuring periodic L1 CLI measurement reporting for the Rx UE. As another example, the Rx UE may perform aperiodic L1 CLI measurements based at least in part on the one or more L1 CLI measurement parameters configuring aperiodic L1 CLI measurement reporting for the Rx UE. As another example, the Rx UE may perform semi-persistent L1 CLI measurements based at least in part on the one or more L1 CLI measurement parameters configuring semi-persistent L1 CLI measurement reporting for the Rx UE.

In some aspects, the Rx UE performs the one or more L1 CLI measurements based at least in part on one or more resources identified by the one or more L1 CLI measurement parameters. In some aspects, the Rx UE performs the one or more L1 CLI measurements based at least in part on one or more measurement types identified by the one or more L1 CLI measurement parameters. In some aspects, the Rx UE performs the one or more L1 CLI measurements using one or more receive beams identified by the one or more L1 CLI measurement parameters. In some aspects, the Rx UE performs the one or more L1 CLI measurements based at least in part on identifying a value associated with a trigger state for L1 CLI measurement identified by the one or more L1 CLI measurement parameters. In some aspects, the Rx UE performs the one or more L1 CLI measurements based at least in part on receiving a MAC-CE activation for L1 CLI measurement identified by the one or more L1 CLI measurement parameters.

As shown by reference number 550, the Rx UE transmits the L1 CLI measurement report to the base station. In some aspects, the Rx UE transmits the L1 CLI measurement report periodically based on the one or more L1 CLI measurement parameters. In some aspects, the Rx UE transmits the L1 CLI measurement report aperiodically based on the one or more L1 CLI measurement parameters. In some aspects, the Rx UE transmits the L1 CLI measurement report semi-persistently based on the one or more L1 CLI measurement parameters.

As shown by reference number 560, the base station may configure beam selection for the Rx UE and/or the Tx UE based at least in part on the L1 CLI measurement report. For example, the base station may configure, based at least in part on the L1 CLI measurement report, a receive beam for the Rx UE and/or a transmit beam for the Tx UE to reduce and/or minimize CLI for downlink reception for the Rx UE. In this way, the L1 CLI measurement report can be taken into account for scheduling of communications (such as, though not exclusively, FD communications), which reduces interference, increases throughput, and improves reliability.

As indicated above, FIG. 5 is provided as an example. Other examples may differ from what is described with regard to FIG. 5.

FIG. 6 is a diagram illustrating an example process 600 performed, for example, by a UE, in accordance with the present disclosure. Example process 600 is an example where the UE (e.g., a UE 120 of FIGS. 1, 2, and/or 4, a UE 302 of FIGS. 3A-3C, the Rx UE of FIG. 5, the apparatus 800 described in connection with FIG. 8) performs operations associated with L1 CLI measurement reporting.

As shown in FIG. 6, in some aspects, process 600 may include receiving an indication of one or more L1 CLI measurement parameters (block 610). For example, the UE (e.g., using communication manager 140 and/or reception component 802, depicted in FIG. 8) may receive an indication of one or more L1 CLI measurement parameters, as described above.

As further shown in FIG. 6, in some aspects, process 600 may include transmitting an L1 CLI measurement report based at least in part on the one or more L1 CLI measurement parameters (block 620). For example, the UE (e.g., using communication manager 140 and/or transmission component 804, depicted in FIG. 8) may transmit an L1 CLI measurement report based at least in part on the one or more L1 CLI measurement parameters, as described above.

Process 600 may include additional aspects, such as any single aspect or any combination of aspects described below and/or in connection with one or more other processes described elsewhere herein.

In a first aspect, receiving the indication of the one or more L1 CLI measurement parameters comprises receiving the indication of the one or more L1 CLI measurement parameters in at least one of an L1 CSI resource configuration (CSI-ResourceConfig) IE, or an L1 CLI resource configuration (L1-CLI-ResourceConfig) IE.

In a second aspect, alone or in combination with the first aspect, transmitting the L1 CLI measurement report comprises transmitting a periodic L1 CLI measurement report.

In a third aspect, alone or in combination with one or more of the first and second aspects, the one or more L1 CLI measurement parameters comprise at least one of an SRS resource set list (srs-ResourceSetList), or a CLI RSSI resource set list (cli-RSSI-ResourceSetList).

In a fourth aspect, alone or in combination with one or more of the first through third aspects, the SRS resource set list indicates an SRS resource for CLI measurement, and the one or more L1 CLI measurement parameters comprise at least one of QCL information associated with a receive beam for CLI measurement using the SRS resource, or a panel identifier associated with the receive beam for CLI measurement using the SRS resource.

In a fifth aspect, alone or in combination with one or more of the first through fourth aspects, the CLI RSSI resource set list indicates an RSSI resource for CLI measurement, and the one or more L1 CLI measurement parameters comprise at least one of QCL information associated with a receive beam for CLI measurement using the RSSI resource, or a panel identifier associated with the receive beam for CLI measurement using the RSSI resource.

In a sixth aspect, alone or in combination with one or more of the first through fifth aspects, the one or more L1 CLI measurement parameters comprise at least one of an L1 CLI SRS reference signal received power (CLI-SRS-RSRP) measurement parameter, or an L1 CLI received signal strength indicator (CLI-RSSI) measurement parameter, and receiving the indication of the one or more L1 CLI measurement parameters comprises receiving the indication of the one or more L1 CLI measurement parameters in at least one of an L1 CSI report configuration (CSI-ReportConfig) IE, or an L1 CLI report configuration (L1-CLI-ReportConfig) IE.

In a seventh aspect, alone or in combination with one or more of the first through sixth aspects, receiving the indication of the one or more L1 CLI measurement parameters comprises receiving the indication of the one or more L1 CLI measurement parameters in an L1 CLI aperiodic trigger state list (CLI-AperiodicTriggerStateList) IE in a DCI communication.

In an eighth aspect, alone or in combination with one or more of the first through seventh aspects, the L1 CLI aperiodic trigger state list IE indicates one or more trigger states for transmitting the L1 CLI measurement report, and process 600 includes receiving an indication of a value associated with a trigger state of the one or more trigger states, wherein the trigger state is linked to an L1 channel state information report configuration identifier (CSI-ReportConfigId) associated with at least one of a CLI-SRS resource set or a CLI received signal strength indicator (CLI-RSSI) resource set, and wherein transmitting the L1 CLI measurement report comprises transmitting an aperiodic L1 CLI measurement report based at least in part on the indication of the value associated with the trigger state.

In a ninth aspect, alone or in combination with one or more of the first through eighth aspects, receiving the indication of the one or more L1 CLI measurement parameters comprises receiving the indication of the one or more L1 CLI measurement parameters in an L1 CLI semi-persistent on PUSCH trigger state list (CLI-SemiPersistentOnPUSCH-TriggerStateList) IE.

In a tenth aspect, alone or in combination with one or more of the first through ninth aspects, the L1 CLI semi-persistent on PUSCH trigger state list IE indicates one or more trigger states for transmitting the L1 CLI measurement report, and process 600 includes receiving an indication of a trigger state of the one or more trigger states, wherein transmitting the L1 CLI measurement report comprises transmitting a semi-persistent L1 CLI measurement report based at least in part on the indication of the trigger state.

In an eleventh aspect, alone or in combination with one or more of the first through tenth aspects, receiving the indication of the trigger state comprises receiving a MAC-CE indicating activation of semi-persistent L1 CLI measurement reporting.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a base station, in accordance with the present disclosure. Example process 700 is an example where the base station (e.g., a base station 110 of FIGS. 1, 2, and/or 4, a base station 304 of FIGS. 3A-3C, the base station of FIG. 5, the apparatus 900 described in connection with FIG. 9) performs operations associated with L1 measurement reporting.

As shown in FIG. 7, in some aspects, process 700 may include transmitting an indication of one or more L1 CLI measurement parameters (block 710). For example, the base station (e.g., using communication manager 150 and/or transmission component 904, depicted in FIG. 9) may transmit an indication of one or more L1 CLI measurement parameters, as described above.

As further shown in FIG. 7, in some aspects, process 700 may include receiving an L1 CLI measurement report based at least in part on the one or more L1 CLI measurement parameters (block 720). For example, the base station (e.g., using communication manager 150 and/or reception component 902, depicted in FIG. 9) may receive an L1 CLI measurement report based at least in part on the one or more L1 CLI measurement parameters, as described above.

Process 700 may include additional aspects, such as any single aspect or any combination of aspects described below and/or in connection with one or more other processes described elsewhere herein.

In a first aspect, transmitting the indication of the one or more L1 CLI measurement parameters comprises transmitting the indication of the one or more L1 CLI measurement parameters in at least one of an L1 CSI resource configuration (CSI-ResourceConfig) IE, or an L1 CLI resource configuration (L1-CLI-ResourceConfig) IE.

In a second aspect, alone or in combination with the first aspect, receiving the L1 CLI measurement report comprises receiving a periodic L1 CLI measurement report.

In a third aspect, alone or in combination with one or more of the first and second aspects, the one or more L1 CLI measurement parameters comprise at least one of an SRS resource set list (srs-ResourceSetList), or a CLI RSSI resource set list (cli-RSSI-ResourceSetList).

In a fourth aspect, alone or in combination with one or more of the first through third aspects, the SRS resource set list indicates an SRS resource for CLI measurement, and the one or more L1 CLI measurement parameters comprise at least one of QCL information associated with a receive beam for CLI measurement using the SRS resource, or a panel identifier associated with the receive beam for CLI measurement using the SRS resource.

In a fifth aspect, alone or in combination with one or more of the first through fourth aspects, the CLI RSSI resource set list indicates an RSSI resource for CLI measurement, and the one or more L1 CLI measurement parameters comprise at least one of QCL information associated with a receive beam for CLI measurement using the RSSI resource, or a panel identifier associated with the receive beam for CLI measurement using the RSSI resource.

In a sixth aspect, alone or in combination with one or more of the first through fifth aspects, the one or more L1 CLI measurement parameters comprise at least one of an L1 CLI SRS reference signal received power (CLI-SRS-RSRP) measurement parameter, or an L1 CLI received signal strength indicator (CLI-RSSI) measurement parameter, and transmitting the indication of the one or more L1 CLI measurement parameters comprises transmitting the indication of the one or more L1 CLI measurement parameters in at least one of an L1 CSI report configuration (CSI-ReportConfig) IE, or an L1 CLI report configuration (L1-CLI-ReportConfig) IE.

In a seventh aspect, alone or in combination with one or more of the first through sixth aspects, transmitting the indication of the one or more L1 CLI measurement parameters comprises transmitting the indication of the one or more L1 CLI measurement parameters in an L1 CLI aperiodic trigger state list (CLI-AperiodicTriggerStateList) IE in a downlink control information (DCI) communication.

In an eighth aspect, alone or in combination with one or more of the first through seventh aspects, the L1 CLI aperiodic trigger state list IE indicates one or more trigger states for transmitting the L1 CLI measurement report, and process 700 includes transmitting an indication of a value associated with a trigger state of the one or more trigger states, wherein the trigger state is linked to an L1 channel state information report configuration identifier (CSI-ReportConfigId) associated with at least one of a CLI-SRS resource set or a CLI received signal strength indicator (CLI-RSSI) resource set, and wherein receiving the L1 CLI measurement report comprises receiving an aperiodic L1 CLI measurement report based at least in part on the indication of the value associated with the trigger state.

In a ninth aspect, alone or in combination with one or more of the first through eighth aspects, transmitting the indication of the one or more L1 CLI measurement parameters comprises transmitting the indication of the one or more L1 CLI measurement parameters in an L1 CLI semi-persistent on PUSCH trigger state list (CLI-SemiPersistentOnPUSCH-TriggerStateList) IE.

In a tenth aspect, alone or in combination with one or more of the first through ninth aspects, the L1 CLI semi-persistent on PUSCH trigger state list IE indicates one or more trigger states for transmitting the L1 CLI measurement report, and process 700 includes transmitting an indication of a trigger state of the one or more trigger states, and wherein receiving the L1 CLI measurement report comprises receiving a semi-persistent L1 CLI measurement report based at least in part on the indication of the trigger state.

In an eleventh aspect, alone or in combination with one or more of the first through tenth aspects, transmitting the indication of the trigger state comprises transmitting a MAC-CE indicating activation of semi-persistent L1 CLI measurement reporting.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE (e.g., a UE 120 of FIGS. 1, 2, and/or 4, a UE 302 of FIGS. 3A-3C, the Rx UE of FIG. 5), or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 140. The communication manager 140 may include one or more of a measurement component 808 and/or a report generation component 810, among other examples.

In some aspects, the apparatus 800 may be configured to perform one or more operations described herein in connection with FIGS. 3-5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The reception component 802 may receive (e.g., from the apparatus 806) an indication of one or more L1 CLI measurement parameters. The transmission component 804 may transmit (e.g., to the apparatus 806) an L1 CLI measurement report based at least in part on the one or more L1 CLI measurement parameters. In some aspects, the measurement component 808 (or the communication manager 140 using the measurement component 808) performs one or more L1 CLI measurements (e.g., based at least in part on a transmission from another apparatus such as a UE) based at least in part on the one or more L1 CLI measurement parameters. In some aspects, the report generation component 810 (or the communication manager 140 using the report generation component 810) generates the L1 CLI measurement report based at least in part on the one or more L1 CLI measurement parameters and/or based at least in part on results of the one or more L1 CLI measurements performed by the measurement component 808.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a base station (e.g., a base station 110 of FIGS. 1, 2, and/or 4, a base station 304 of FIGS. 3A-3C, the base station of FIG. 5), or a base station may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 150. The communication manager 150 may include a configuration component 908, among other examples.

In some aspects, the apparatus 900 may be configured to perform one or more operations described herein in connection with FIGS. 3-5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the base station described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the base station described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the base station described in connection with FIG. 2. In some aspects, the transmission component 904 may be co-located with the reception component 902 in a transceiver.

The transmission component 904 may transmit (e.g., to the apparatus 906) an indication of one or more L1 CLI measurement parameters. The reception component 902 may receive (e.g., from the apparatus 906) an L1 CLI measurement report based at least in part on the one or more L1 CLI measurement parameters. In some aspects, the configuration component 908 (or the communication manager 150 using the configuration component 908) may generate the one or more L1 CLI measurement parameters, and/or may generate a configuration including the one or more L1 CLI measurement parameters. In some aspects, the transmission component 904 may transmit (e.g., to the apparatus 906) the configuration generated by the configuration component 908.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: receiving an indication of one or more layer 1 (L1) cross-link interference (CLI) measurement parameters; and transmitting an L1 CLI measurement report based at least in part on the one or more L1 CLI measurement parameters.

Aspect 2: The method of Aspect 1, wherein receiving the indication of the one or more L1 CLI measurement parameters comprises receiving the indication of the one or more L1 CLI measurement parameters in at least one of: an L1 channel state information (CSI) resource configuration (CSI-ResourceConfig) information element (IE), or an L1 CLI resource configuration (L1-CLI-ResourceConfig) IE.

Aspect 3: The method of Aspect 1 or 2, wherein transmitting the L1 CLI measurement report comprises transmitting a periodic L1 CLI measurement report.

Aspect 4: The method of one or more of Aspects 1-3, wherein the one or more L1 CLI measurement parameters comprise at least one of: a sounding reference signal (SRS) resource set list (srs-ResourceSetList), or a CLI received signal strength indicator (RSSI) resource set list (cli-RSSI-ResourceSetList).

Aspect 5: The method of Aspect 4, wherein the SRS resource set list indicates an SRS resource for CLI measurement; and wherein the one or more L1 CLI measurement parameters comprise at least one of: quasi-co-location (QCL) information associated with a receive beam for CLI measurement using the SRS resource, or a panel identifier associated with the receive beam for CLI measurement using the SRS resource.

Aspect 6: The method of Aspect 4 or 5, wherein the CLI RSSI resource set list indicates an RSSI resource for CLI measurement; and wherein the one or more L1 CLI measurement parameters comprise at least one of: quasi-co-location (QCL) information associated with a receive beam for CLI measurement using the RSSI resource, or a panel identifier associated with the receive beam for CLI measurement using the RSSI resource.

Aspect 7: The method of one or more of Aspects 1-6, wherein the one or more L1 CLI measurement parameters comprise at least one of: an L1 CLI SRS reference signal received power (CLI-SRS-RSRP) measurement parameter, or an L1 CLI received signal strength indicator (CLI-RSSI) measurement parameter; and wherein receiving the indication of the one or more L1 CLI measurement parameters comprises receiving the indication of the one or more L1 CLI measurement parameters in at least one of: an L1 channel state information (CSI) report configuration (CSI-ReportConfig) information element (IE), or an L1 CLI report configuration (L1-CLI-ReportConfig) IE.

Aspect 8: The method of one or more of Aspects 1-7, wherein receiving the indication of the one or more L1 CLI measurement parameters comprises receiving the indication of the one or more L1 CLI measurement parameters in an L1 CLI aperiodic trigger state list (CLI-AperiodicTriggerStateList) information element (IE) in a downlink control information (DCI) communication.

Aspect 9: The method of Aspect 8, wherein the L1 CLI aperiodic trigger state list IE indicates one or more trigger states for transmitting the L1 CLI measurement report; wherein the method further comprises receiving an indication of a value associated with a trigger state of the one or more trigger states wherein the trigger state is linked to an L1 channel state information report configuration identifier (CSI-ReportConfigId) associated with at least one of a CLI-SRS resource set or a CLI received signal strength indicator (CLI-RSSI) resource set; and wherein transmitting the L1 CLI measurement report comprises transmitting an aperiodic L1 CLI measurement report based at least in part on the indication of the value associated with the trigger state.

Aspect 10: The method of one or more of Aspects 1-9, wherein receiving the indication of the one or more L1 CLI measurement parameters comprises receiving the indication of the one or more L1 CLI measurement parameters in an L1 CLI semi-persistent on physical uplink shared channel (PUSCH) trigger state list (CLI-SemiPersistentOnPUSCH-TriggerStateList) information element (IE).

Aspect 11: The method of Aspect 10, wherein the L1 CLI semi-persistent on PUSCH trigger state list IE indicates one or more trigger states for transmitting the L1 CLI measurement report; wherein the method further comprises receiving an indication of a trigger state of the one or more trigger states; and wherein transmitting the L1 CLI measurement report comprises transmitting a semi-persistent L1 CLI measurement report based at least in part on the indication of the trigger state.

Aspect 12: The method of Aspect 11, wherein receiving the indication of the trigger state comprises receiving a medium access control control channel (MAC-CE) indicating activation of semi-persistent L1 CLI measurement reporting.

Aspect 13: A method of wireless communication performed by a base station, comprising: transmitting an indication of one or more layer 1 (L1) cross-link interference (CLI) measurement parameters; and receiving an L1 CLI measurement report based at least in part on the one or more L1 CLI measurement parameters.

Aspect 14: The method of Aspect 13, wherein transmitting the indication of the one or more L1 CLI measurement parameters comprises transmitting the indication of the one or more L1 CLI measurement parameters in at least one of: an L1 channel state information (CSI) resource configuration (CSI-ResourceConfig) information element (IE), or an L1 CLI resource configuration (L1-CLI-ResourceConfig) IE.

Aspect 15: The method of Aspect 13 or 14, wherein receiving the L1 CLI measurement report comprises receiving a periodic L1 CLI measurement report.

Aspect 16: The method of one or more of Aspects 13-15, wherein the one or more L1 CLI measurement parameters comprise at least one of: a sounding reference signal (SRS) resource set list (srs-ResourceSetList), or a CLI received signal strength indicator (RSSI) resource set list (cli-RSSI-ResourceSetList).

Aspect 17: The method of Aspect 16, wherein the SRS resource set list indicates an SRS resource for CLI measurement; and wherein the one or more L1 CLI measurement parameters comprise at least one of: quasi-co-location (QCL) information associated with a receive beam for CLI measurement using the SRS resource, or a panel identifier associated with the receive beam for CLI measurement using the SRS resource.

Aspect 18: The method of Aspect 16 or 17, wherein the CLI RSSI resource set list indicates an RSSI resource for CLI measurement; and wherein the one or more L1 CLI measurement parameters comprise at least one of: quasi-co-location (QCL) information associated with a receive beam for CLI measurement using the RSSI resource, or a panel identifier associated with the receive beam for CLI measurement using the RSSI resource.

Aspect 19: The method of one or more of Aspects 13-18, wherein the one or more L1 CLI measurement parameters comprise at least one of: an L1 CLI SRS reference signal received power (CLI-SRS-RSRP) measurement parameter, or an L1 CLI received signal strength indicator (CLI-RSSI) measurement parameter; and wherein transmitting the indication of the one or more L1 CLI measurement parameters comprises transmitting the indication of the one or more L1 CLI measurement parameters in at least one of: an L1 channel state information (CSI) report configuration (CSI-ReportConfig) information element (IE), or an L1 CLI report configuration (L1-CLI-ReportConfig) IE.

Aspect 20: The method of one or more of Aspects 13-19, wherein transmitting the indication of the one or more L1 CLI measurement parameters comprises transmitting the indication of the one or more L1 CLI measurement parameters in an L1 CLI aperiodic trigger state list (CLI-AperiodicTriggerStateList) information element (IE) in a downlink control information (DCI) communication.

Aspect 21: The method of Aspect 20, wherein the L1 CLI aperiodic trigger state list IE indicates one or more trigger states for transmitting the L1 CLI measurement report; wherein the method further comprises transmitting an indication of a value associated with a trigger state of the one or more trigger states, wherein the trigger state is linked to an L1 channel state information report configuration identifier (CSI-ReportConfigId) associated with at least one of a CLI-SRS resource set or a CLI received signal strength indicator (CLI-RSSI) resource set; and wherein receiving the L1 CLI measurement report comprises receiving an aperiodic L1 CLI measurement report based at least in part on the indication of the value associated with the trigger state.

Aspect 22: The method of one or more of Aspects 13-21, wherein transmitting the indication of the one or more L1 CLI measurement parameters comprises transmitting the indication of the one or more L1 CLI measurement parameters in an L1 CLI semi-persistent on physical uplink shared channel (PUSCH) trigger state list (CLI-SemiPersistentOnPUSCH-TriggerStateList) information element (IE).

Aspect 23: The method of Aspect 22, wherein the L1 CLI semi-persistent on PUSCH trigger state list IE indicates one or more trigger states for transmitting the L1 CLI measurement report; wherein the method further comprises transmitting an indication of a trigger state of the one or more trigger states; and wherein receiving the L1 CLI measurement report comprises receiving a semi-persistent L1 CLI measurement report based at least in part on the indication of the trigger state.

Aspect 24: The method of Aspect 23, wherein transmitting the indication of the trigger state comprises transmitting a medium access control control channel (MAC-CE) indicating activation of semi-persistent L1 CLI measurement reporting.

Aspect 25: An apparatus for wireless communication at a device, comprising a processor; memory coupled with the processor; and instructions stored in the memory and executable by the processor to cause the apparatus to perform the method of one or more of Aspects 1-12.

Aspect 26: A device for wireless communication, comprising a memory and one or more processors coupled to the memory, the one or more processors configured to perform the method of one or more of Aspects 1-12.

Aspect 27: An apparatus for wireless communication, comprising at least one means for performing the method of one or more of Aspects 1-12.

Aspect 28: A non-transitory computer-readable medium storing code for wireless communication, the code comprising instructions executable by a processor to perform the method of one or more of Aspects 1-12.

Aspect 29: A non-transitory computer-readable medium storing a set of instructions for wireless communication, the set of instructions comprising one or more instructions that, when executed by one or more processors of a device, cause the device to perform the method of one or more of Aspects 1-12.

Aspect 30: An apparatus for wireless communication at a device, comprising a processor; memory coupled with the processor; and instructions stored in the memory and executable by the processor to cause the apparatus to perform the method of one or more of Aspects 13-24.

Aspect 31: A device for wireless communication, comprising a memory and one or more processors coupled to the memory, the one or more processors configured to perform the method of one or more of Aspects 13-24.

Aspect 32: An apparatus for wireless communication, comprising at least one means for performing the method of one or more of Aspects 13-24.

Aspect 33: A non-transitory computer-readable medium storing code for wireless communication, the code comprising instructions executable by a processor to perform the method of one or more of Aspects 13-24.

Aspect 34: A non-transitory computer-readable medium storing a set of instructions for wireless communication, the set of instructions comprising one or more instructions that, when executed by one or more processors of a device, cause the device to perform the method of one or more of Aspects 13-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving an indication of one or more layer 1 (L1) cross-link interference (CLI) measurement parameters; and
transmitting an L1 CLI measurement report based at least in part on the one or more L1 CLI measurement parameters.

2. The method of claim 1, wherein receiving the indication of the one or more L1 CLI measurement parameters comprises receiving the indication of the one or more L1 CLI measurement parameters in at least one of:
an L1 channel state information (CSI) resource configuration (CSI-ResourceConfig) information element (IE), or
an L1 CLI resource configuration (L1-CLI-ResourceConfig).

3. The method of claim 2, wherein transmitting the L1 CLI measurement report comprises transmitting a periodic L1 CLI measurement report.

4. The method of claim 1, wherein the one or more L1 CLI measurement parameters comprise at least one of:
a sounding reference signal (SRS) resource set list (srs-ResourceSetList), or
a CLI received signal strength indicator (RSSI) resource set list (cli-RSSI-ResourceSetList).

5. The method of claim 4, wherein the SRS resource set list indicates an SRS resource for CLI measurement; and
wherein the one or more L1 CLI measurement parameters comprise at least one of:
quasi-co-location (QCL) information associated with a receive beam for CLI measurement using the SRS resource, or
a panel identifier associated with the receive beam for CLI measurement using the SRS resource.

6. The method of claim 4, wherein the CLI RSSI resource set list indicates an RSSI resource for CLI measurement; and
wherein the one or more L1 CLI measurement parameters comprise at least one of:
quasi-co-location (QCL) information associated with a receive beam for CLI measurement using the RSSI resource, or
a panel identifier associated with the receive beam for CLI measurement using the RSSI resource.

7. The method of claim 1, wherein the one or more L1 CLI measurement parameters comprise at least one of:
an L1 CLI SRS reference signal received power (CLI-SRS-RSRP) measurement parameter, or
an L1 CLI received signal strength indicator (CLI-RSSI) measurement parameter; and
wherein receiving the indication of the one or more L1 CLI measurement parameters comprises receiving the indication of the one or more L1 CLI measurement parameters in at least one of:
an L1 channel state information (CSI) report configuration (CSI-ReportConfig) information element (IE), or
an L1 CLI report configuration (L1-CLI-ReportConfig) IE.

8. The method of claim 1, wherein receiving the indication of the one or more L1 CLI measurement parameters comprises receiving the indication of the one or more L1 CLI measurement parameters in an L1 CLI aperiodic trigger state list (CLI-AperiodicTriggerStateList) information element (IE) in a downlink control information (DCI) communication.

9. The method of claim 8, wherein the L1 CLI aperiodic trigger state list IE indicates one or more trigger states for transmitting the L1 CLI measurement report;
wherein the method further comprises receiving an indication of a value associated with a trigger state of the one or more trigger states,
wherein the trigger state is linked to an L1 channel state information report configuration identifier (CSI-ReportConfigId) associated with at least one of a CLI-SRS resource set or a CLI received signal strength indicator (CLI-RSSI) resource set; and
wherein transmitting the L1 CLI measurement report comprises transmitting an aperiodic L1 CLI measurement report based at least in part on the indication of the value associated with the trigger state.

10. The method of claim 1, wherein receiving the indication of the one or more L1 CLI measurement parameters comprises receiving the indication of the one or more L1 CLI measurement parameters in an L1 CLI semi-persistent on physical uplink shared channel (PUSCH) trigger state list (CLI-SemiPersistentOnPUSCH-TriggerStateList) information element (IE).

11. The method of claim 10, wherein the L1 CLI semi-persistent on PUSCH trigger state list IE indicates one or more trigger states for transmitting the L1 CLI measurement report;
wherein the method further comprises receiving an indication of a trigger state of the one or more trigger states; and
wherein transmitting the L1 CLI measurement report comprises transmitting a semi-persistent L1 CLI measurement report based at least in part on the indication of the trigger state.

12. The method of claim 11, wherein receiving the indication of the trigger state comprises receiving a medium access control control channel (MAC-CE) indicating activation of semi-persistent L1 CLI measurement reporting.

13. A method of wireless communication performed by a base station, comprising:
transmitting an indication of one or more layer 1 (L1) cross-link interference (CLI) measurement parameters; and
receiving an L1 CLI measurement report based at least in part on the one or more L1 CLI measurement parameters.

14. The method of claim 13, wherein transmitting the indication of the one or more L1 CLI measurement parameters comprises transmitting the indication of the one or more L1 CLI measurement parameters in at least one of:
an L1 channel state information (CSI) resource configuration (CSI-ResourceConfig) information element (IE), or
an L1 CLI resource configuration (L1-CLI-ResourceConfig) IE.

15. The method of claim 14, wherein receiving the L1 CLI measurement report comprises receiving a periodic L1 CLI measurement report.

16. The method of claim 13, wherein the one or more L1 CLI measurement parameters comprise at least one of:
a sounding reference signal (SRS) resource set list (srs-ResourceSetList), or
a CLI received signal strength indicator (RSSI) resource set list (cli-RSSI-ResourceSetList).

17. The method of claim 16, wherein the SRS resource set list indicates an SRS resource for CLI measurement; and
wherein the one or more L1 CLI measurement parameters comprise at least one of:
quasi-co-location (QCL) information associated with a receive beam for CLI measurement using the SRS resource, or
a panel identifier associated with the receive beam for CLI measurement using the SRS resource.

18. The method of claim 16, wherein the CLI RSSI resource set list indicates an RSSI resource for CLI measurement; and
wherein the one or more L1 CLI measurement parameters comprise at least one of:
quasi-co-location (QCL) information associated with a receive beam for CLI measurement using the RSSI resource, or
a panel identifier associated with the receive beam for CLI measurement using the RSSI resource.

19. The method of claim 13, wherein the one or more L1 CLI measurement parameters comprise at least one of:
an L1 CLI SRS reference signal received power (CLI-SRS-RSRP) measurement parameter, or
an L1 CLI received signal strength indicator (CLI-RSSI) measurement parameter; and
wherein transmitting the indication of the one or more L1 CLI measurement parameters comprises transmitting the indication of the one or more L1 CLI measurement parameters in at least one of:
an L1 channel state information (CSI) report configuration (CSI-ReportConfig) information element (IE), or
an L1 CLI report configuration (L1-CLI-ReportConfig) IE.

20. The method of claim 13, wherein transmitting the indication of the one or more L1 CLI measurement parameters comprises transmitting the indication of the one or more L1 CLI measurement parameters in an L1 CLI aperiodic trigger state list (CLI-AperiodicTriggerStateList) information element (IE) in a downlink control information (DCI) communication.

21. The method of claim 20, wherein the L1 CLI aperiodic trigger state list IE indicates one or more trigger states for transmitting the L1 CLI measurement report;
wherein the method further comprises transmitting an indication of a value associated with a trigger state of the one or more trigger states,
wherein the trigger state is linked to an L1 channel state information report configuration identifier (CSI-ReportConfigId) associated with at least one of a CLI-SRS resource set or a CLI received signal strength indicator (CLI-RSSI) resource set; and
wherein receiving the L1 CLI measurement report comprises receiving an aperiodic L1 CLI measurement report based at least in part on the indication of the value associated with the trigger state.

22. The method of claim 13, wherein transmitting the indication of the one or more L1 CLI measurement parameters comprises transmitting the indication of the one or more L1 CLI measurement parameters in an L1 CLI semi-persistent on physical uplink shared channel (PUSCH) trigger state list (CLI-SemiPersistentOnPUSCH-TriggerStateList) information element (IE).

23. The method of claim 22, wherein the L1 CLI semi-persistent on PUSCH trigger state list IE indicates one or more trigger states for transmitting the L1 CLI measurement report;
wherein the method further comprises transmitting an indication of a trigger state of the one or more trigger states; and
wherein receiving the L1 CLI measurement report comprises receiving a semi-persistent L1 CLI measurement report based at least in part on the indication of the trigger state.

24. The method of claim 23, wherein transmitting the indication of the trigger state comprises transmitting a medium access control control channel (MAC-CE) indicating activation of semi-persistent L1 CLI measurement reporting.

25. A user equipment (UE) for wireless communication, comprising:
a memory; and
one or more processors, coupled to the memory, configured to:
receive an indication of one or more layer 1 (L1) cross-link interference (CLI) measurement parameters; and
transmit an L1 CLI measurement report based at least in part on the one or more L1 CLI measurement parameters.

26. The UE of claim 25, wherein the one or more processors, to receive the indication of the one or more L1 CLI measurement parameters, are configured to receive the indication of the one or more L1 CLI measurement parameters in at least one of:
an L1 channel state information (CSI) resource configuration (CSI-ResourceConfig) information element (IE), or
an L1 CLI resource configuration (L1-CLI-ResourceConfig) IE.

27. The UE of claim 25, wherein the one or more L1 CLI measurement parameters comprise at least one of:
an L1 CLI SRS reference signal received power (CLI-SRS-RSRP) measurement parameter, or
an L1 CLI received signal strength indicator (CLI-RSSI) measurement parameter; and
wherein the one or more processors, to receive the indication of the one or more L1 CLI measurement parameters, are configured to receive the indication of the one or more L1 CLI measurement parameters in at least one of:
an L1 channel state information (CSI) report configuration (CSI-ReportConfig) information element (IE), or
an L1 CLI report configuration (L1-CLI-ReportConfig) IE.

28. A base station for wireless communication, comprising:
a memory; and
one or more processors, coupled to the memory, configured to:
transmit an indication of one or more layer 1 (L1) cross-link interference (CLI) measurement parameters; and
receive an L1 CLI measurement report based at least in part on the one or more L1 CLI measurement parameters.

29. The base station of claim 28, wherein the one or more processors, to transmit the indication of the one or more L1 CLI measurement parameters, are configured to transmit the indication of the one or more L1 CLI measurement parameters in at least one of:
an L1 channel state information (CSI) resource configuration (CSI-ResourceConfig) information element (IE), or
an L1 CLI resource configuration (L1-CLI-ResourceConfig) IE.

30. The base station of claim 28, wherein the one or more L1 CLI measurement parameters comprise at least one of:
an L1 CLI SRS reference signal received power (CLI-SRS-RSRP) measurement parameter, or
an L1 CLI received signal strength indicator (CLI-RSSI) measurement parameter; and
wherein the one or more processors, to transmit the indication of the one or more L1 CLI measurement parameters, are configured to transmit the indication of the one or more L1 CLI measurement parameters in at least one of:
an L1 channel state information (CSI) report configuration (CSI-ReportConfig) information element (IE), or
an L1 CLI report configuration (L1-CLI-ReportConfig) IE.
